(19) United States
(12) Patent Application Publication
(10) Pub. No.: US 2015/0078135 A1
(43) Pub. Date: Mar. 19, 2015

(54) METHODS AND SYSTEMS FOR UNDERWATER LOCATION

(71) Applicant: Liquivision Products, Inc., Burnaby (CA)

(72) Inventor: Eric Abdel FATTAH, Burnaby (CA)

(73) Assignee: Liquivision Products, Inc., Burnaby (CA)

(21) Appl. No.: 14/032,068

(22) Filed: Sep. 19, 2013

(51) Int. Cl. G01S 3/802

(52) U.S. Cl. CPC G01S 3/802
USPC 367/118

(57) ABSTRACT

An electronic device for locating an underwater target transmitting a signal comprises a housing; a display; at least one transducer for receiving the signal from the underwater target; a processor connected to receive signals from the at least one transducer and to control the display; and a memory storing computer readable instructions which, when executed by the processor, cause the processor to: determine a bearing to the underwater target based on the signals from the at least one transducer; determine an uncertainty in the determined bearing; and, control the display to display the determined bearing and uncertainty.

### TECHNICAL FIELD

The present disclosure relates to location of underwater signal sources.

### BACKGROUND

Limited visibility in underwater environments means that locating an object can often be difficult. A scuba diver, submersible or remotely operated vehicle will often need to locate an object underwater, whether another scuba diver, submersible, remotely operated vehicle, fixed location or device. Due to the fact that light and electromagnetic waves travel poorly underwater due to absorption, acoustic means of communication and location are often used underwater. Acoustic location beacons or ‘pingers’ are often used to mark a person, vehicle, device or location underwater. Such transmitter beacons will intermittently transmit an acoustic vibration through the water, to a receiver device some distance away. The receiver device will then attempt to locate the direction of the transmitter. Various methods have been attempted to locate the source direction of an acoustical signal underwater.

The situation is further complicated by the fact that either the receiver, or the target being located, could be moving underwater. Therefore, any directional information leading to the target may become inaccurate as time elapses, as either the receiver or the target move. This requires updating the direction to the target to account for the continued movement between the receiver and the target. Many previous methods used to locate an acoustic signal underwater require a lengthy and complex procedure, just to get a single bearing to the target. As such, having to continuously repeat such a procedure to get a continuously updated bearing towards the target is impractical.

Methods used to get a directional bearing towards the target typically have a certain angular uncertainty associated with the bearing. For example, the receiver device may indicate that the target lies at a compass bearing of 240 degrees, whereas in fact the true bearing is 240 degrees+/−20 degrees due to numerous complexities including acoustical reflections, limited time resolution of digital signal processing algorithms, or approximations used during the direction finding algorithm.

Examples of prior art related to underwater monitoring and communications include the following U.S. patents:
U.S. Pat. No. 6,762,678;
U.S. Pat. No. 6,272,072;
U.S. Pat. No. 5,570,323;
U.S. Pat. No. 5,392,771;
U.S. Pat. No. 8,159,903;
U.S. Pat. No. 8,094,518;
U.S. Pat. No. 8,091,422;
U.S. Pat. No. 8,009,516;
U.S. Pat. No. 7,512,036;
U.S. Pat. No. 7,642,919;
U.S. Pat. No. 7,612,686;
U.S. Pat. No. 7,483,337;
U.S. Pat. No. 7,388,512;
U.S. Pat. No. 7,310,286;
U.S. Pat. No. 7,304,911;
U.S. Pat. No. 7,272,075;
U.S. Pat. No. 7,187,622;
U.S. Pat. No. 7,006,407;
U.S. Pat. No. 6,941,226;
U.S. Pat. No. 6,931,339;
U.S. Pat. No. 6,272,073;
U.S. Pat. No. 6,130,859;
U.S. Pat. No. 6,125,080;
U.S. Pat. No. 5,956,291;
U.S. Pat. No. 5,784,339;
U.S. Pat. No. 5,666,326;
U.S. Pat. No. 5,523,982;
U.S. Pat. No. 5,331,602; and
U.S. Pat. No. 3,986,161

The inventor has determined a need for methods and systems that clearly communicate directional uncertainty to the user, and that may further account for relative motion between the receiver and the target, and continuously update both the bearing to the target and directional uncertainties.

### SUMMARY

One aspect provides an electronic device for locating an underwater target transmitting a signal. The electronic device comprises a housing; a display; at least one transducer for receiving the signal from the underwater target; a processor connected to receive signals from the at least one transducer and to control the display; and a memory storing computer readable instructions which, when executed by the processor, cause the processor to: determine a bearing to the underwater target based on the signals from the at least one transducer; determine an uncertainty in the determined bearing; and, control the display to display the determined bearing and uncertainty.

The display may display a graphical representation of the determined bearing and uncertainty on a generally circular map centered on the electronic device. The graphical representation of the determined bearing and uncertainty may comprise a circular section centered on the determined bearing and having an angular extent based on the uncertainty.

Another aspect provides a method for locating an underwater target transmitting a signal. The method comprises receiving the signal from the underwater target, determining a bearing to the underwater target based on the signal, determining an uncertainty in the determined bearing, and, displaying the determined bearing and uncertainty on a display.

Other aspects and features of the present disclosure will become apparent to those ordinarily skilled in the art upon review of the following description of specific embodiments in conjunction with the accompanying figures.

### DRAWINGS

The following figures set forth embodiments in which like reference numerals denote like parts. Embodiments are illustrated by way of example and not by way of limitation in the accompanying figures.

FIG. 1 shows a receiver device according to one embodiment.

FIG. 2 is a flowchart illustrating an example method according to one embodiment.

FIG. 3 shows the receiver device of FIG. 1 displaying bearing information determined from an example signal.

FIG. 4 shows the receiver device of FIG. 3 in a different orientation.

FIG. 5 is a flowchart illustrating an example method according to one embodiment.

FIG. 6 shows the receiver device of FIG. 1 displaying bearing information determined from another example signal.

FIG. 7 shows the receiver device of FIG. 1 displaying combined bearing information determined from the example signals of FIGS. 3 and 6 according to one embodiment.

FIG. 8 shows the receiver device of FIG. 1 displaying combined bearing information determined from the example signals of FIGS. 3 and 6 according to another embodiment.

FIG. 9 shows the receiver device of FIG. 1 displaying combined bearing information determined from the example signals of FIGS. 3 and 6 and a third signal according to another embodiment.

FIG. 10 shows the receiver device of FIG. 1 displaying combined bearing information determined from example signals according to another embodiment.

FIG. 11 schematically illustrates how a diver can locate a target using the receiver device of FIG. 1.

### DETAILED DESCRIPTION

The present disclosure provides methods and systems for determining and displaying location information of underwater signal sources. Example embodiments are disclosed below in the context of a receiver device having a display, a one or more ultrasonic transducers configured to detect acoustic signals, and a processor connected to the display and the transducers for determining the direction of an acoustic signal. Some embodiments may use a receiver device similar to those described in U.S. patent application Ser. No. 13/966,068 and Ser. No. 13/966,913, which are hereby incorporated by reference herein. Other embodiments may use different types of receiver devices. Examples of methods which may be employed by the processor for determining the direction of an acoustic signal include computing the phase shift between the signal received upon several receiving transducers, or using the relative amplitude of the signal received upon several receiving transducers. Other methods may also be used to determine the direction of an acoustic signal. For example, a device with a single transducer utilizing the Doppler effect, or a device with a single highly directional transducer may be used. Further, although acoustic signals are particularly suitable for underwater environments, it is to be understood that the examples disclosed herein could be adapted for receiver devices configured to determine the direction of other types of signals. For example, the examples disclosed herein could be adapted for receiver devices having non-ultrasonic acoustic transducers, vibrational transducers, or electromagnetic transducers.

The angular uncertainty in the determination of the direction to the signal source or “target” can depend on the method used to calculate the direction, the relative orientation of the receiver device to the signal source, the types and geometry of receiver transducers, details of the electrical circuit(s) used to process and analyze the signals, and other factors. The angular uncertainty could be anywhere from a few degrees to 180 degrees or more. For the purposes of the examples discussed below, an angular uncertainty of 120 degrees (+/−60 degrees) in the directional estimation is assumed.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

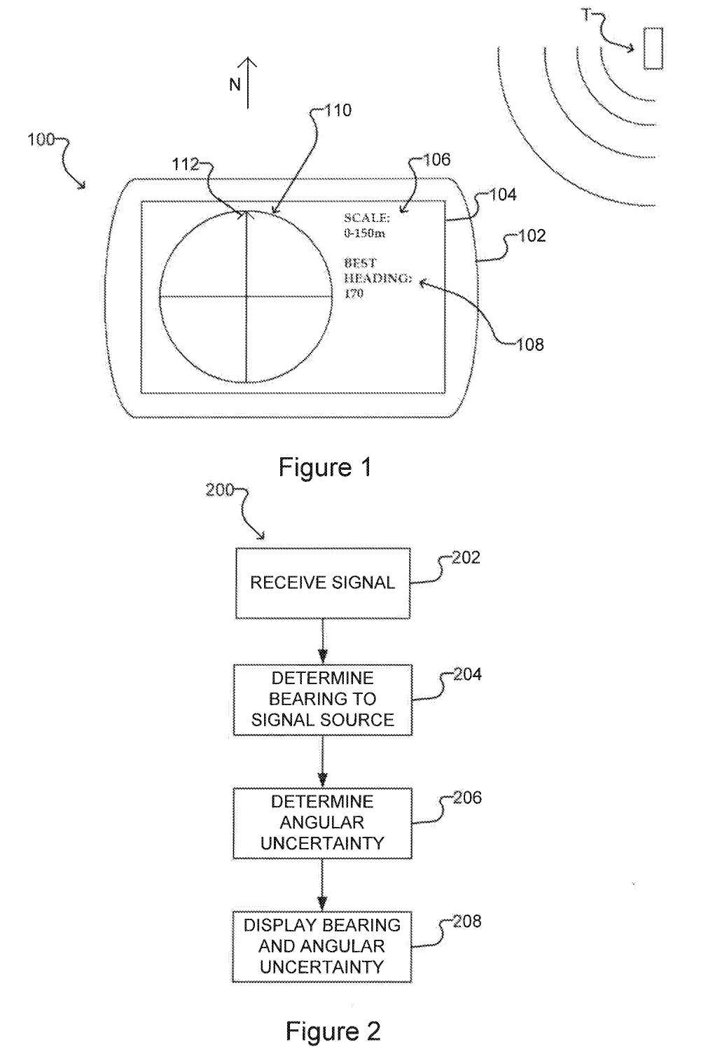

FIG. 1 shows a signal source in the form of a transmitter device or target T which transmits a brief acoustic signal every few seconds, and a receiver device 100 configured to receive acoustic signals. The receiver device 100 comprises housing 102 and a display 104. The housing 102 contains various components (not shown) therein, including a processor, memory for storing instructions executable by the processor, and optionally for storing data relating to received signals, a plurality of ultrasonic transducers, and a digital compass. In this example the housing 102 of the receiver device 100 is shown as being generally rectangular in nature, and the device is configured to be held ‘level’ or approximately parallel to the ocean floor when in use.

The display 104 has a scale indicator 106, a bearing or heading indicator 108, and a generally circular map 110 displayed thereon. The direction of north, indicated by arrow N in the Figures, is indicated by an arrow 112 on the map 110 of the display 104. The center point of the map 110 refers to the receiver device 100 itself, and the surrounding circular area is a representation of the underwater area surrounding the receiver device 100. In embodiments where the receiver device 100 is capable of estimating the distance to the target T, then the scale indicator 106 may be used to indicate the radius of area represented by the circle on the map, for example representing a radius of anything from a few meters to hundreds or thousands of meters. The receiver device 100 may, for example, determine an estimate of the distance to the target T based on the strength of the received signal and/or other factors, by any suitable method. In embodiments where the receiver device 100 is not capable of estimating the distance to the target T, then the scale indicator 106 may be omitted.

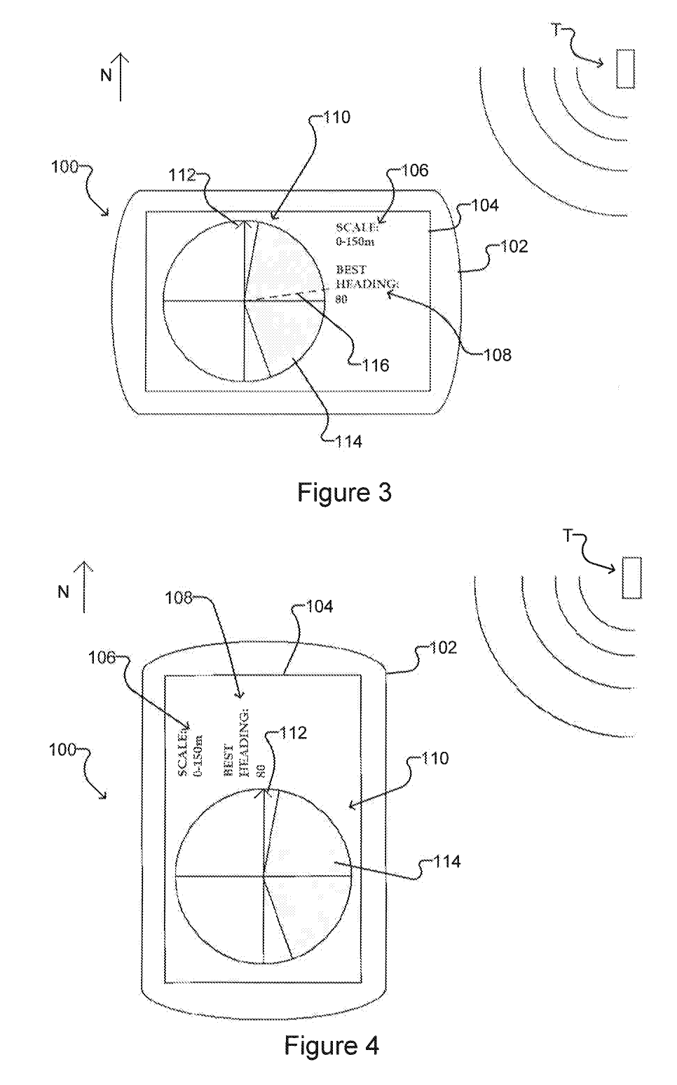

FIG. 2 is a flowchart illustrating steps of an example method 200 carried out by the receiver device 100 according to one embodiment. A signal from the target T is received by transducers of the device at 202. The processor processes signals from the transducers to determine a bearing to the target T at 204 according to any suitable method. The processor then determines an angular uncertainty of the bearing at 206. The angular uncertainty can differ for different signals from the target, depending on a variety of factors including, for example, the orientation of the receiver device 100 with respect to the target T, the strength of the signal, the current conditions. The processor then controls the display 104 to display the determined bearing and uncertainty at 208, for example by displaying a circular sector 114 centered on the determined bearing on the map 110 as shown in FIG. 3. The angular span of the circular sector 114 indicates the uncertainty in the bearing, such that the user can readily determine how reliable the determined bearing is. In the FIG. 3 example, the determined bearing is 80 degrees and the uncertainty is +/−60 degrees. Displaying the determined bearing and uncertainty may also optionally comprise displaying a bearing line 116 on the map 110.

As the receiver device 100 rotates, the processor, by using information from the digital compass, rotates the map 110 and any information thereon, including the circular sector 114 used to represent the determined bearing and uncertainty. For example, FIG. 4 shows the receiver device 100 rotated 90 degrees counterclockwise from the orientation shown in FIG. 3, with the map 110, including the north arrow 112 and circular sector 114 maintaining its orientation.

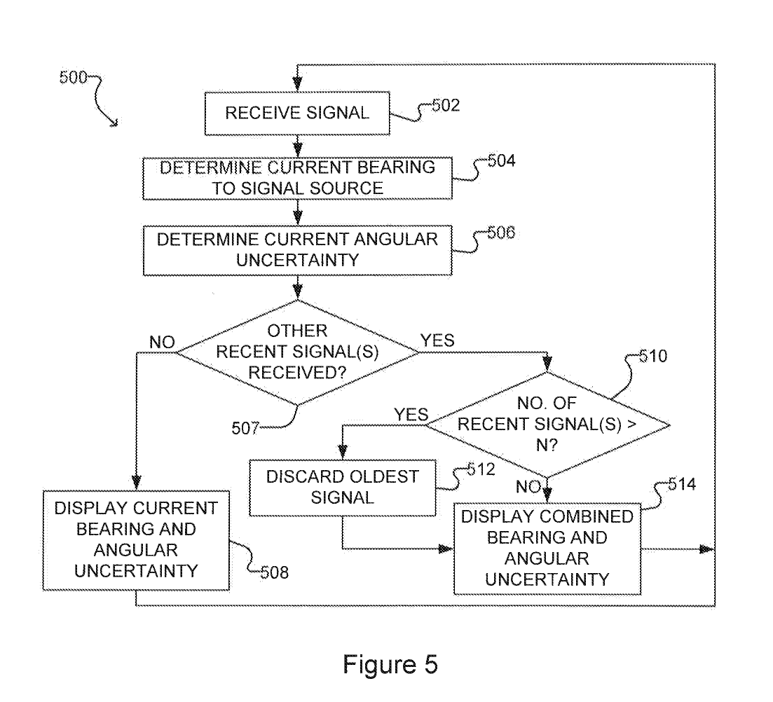

FIG. 5 is a flowchart illustrating steps of another example method 500 carried out by the receiver device 100 according to one embodiment. A signal from the target T is received by transducers of the device at 502. The processor processes signals from the transducers to determine a current bearing to the target T at 504 according to any suitable method. The processor then determines a current angular uncertainty of the bearing at 506. At 507 the processor determines whether any other signals from the target T have been recently received. For example, when a signal is received it may be given a time stamp, and determining at 507 may comprise comparing the time stamp with a current time, and if the time between the time stamp and the current time is less than a predetermined threshold time, considering the signal as a recent signal. If there are no other recent signals (507 NO output), the processor then controls the display 104 to display the determined current bearing and uncertainty at 508, as described above, and awaits a further signal to be received at 502. In some embodiments, the signals are not timestamped and all the signals are considered, regardless of when they were received. In some embodiments, the sequence in which the signals are received is recorded without any timestamps.

If there are other signals to be considered (507 YES output), the processor proceeds to compare the number of signals to be considered with a threshold number N at 510, and if the number of signals exceeds N, the processor may discard the oldest signal at 512, before proceeding to control the display 104 to display combined bearing and uncertainty at 514, as described below. The threshold number N may be any suitable integer greater than one, such as, for example, 2, 3, 4, 5, 6, 7, 8, etc. In some embodiments, the steps at 510 and 512 may be omitted, such that all received signals (or all recently received signals) are used to display the combined bearing and uncertainty.

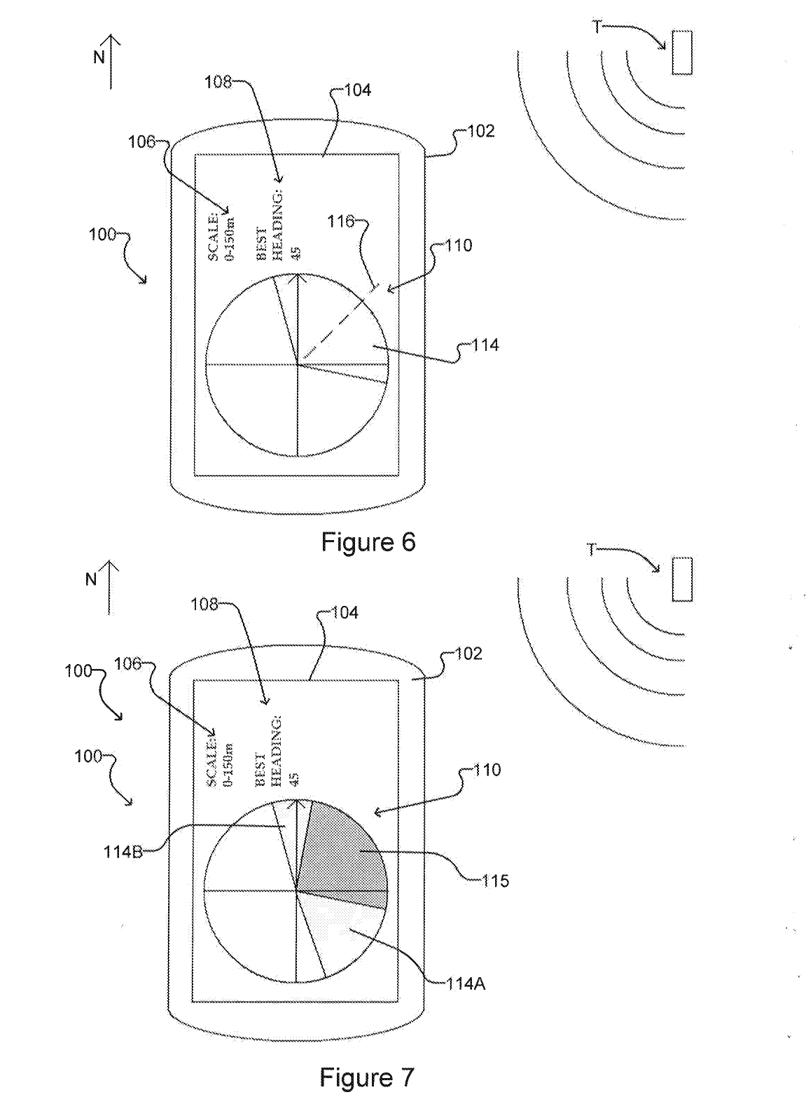

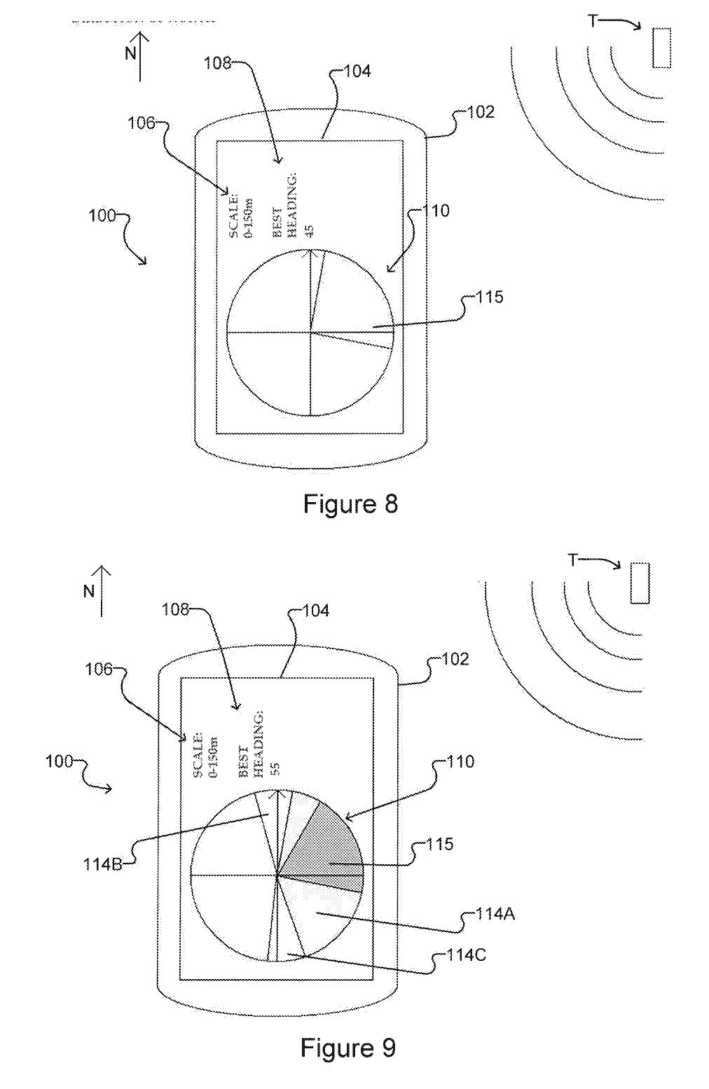

Examples of displaying the combined bearing and uncertainty will now be described with reference to FIGS. 6 to 10. FIG. 6 shows an example bearing and uncertainty display wherein the circular section 114 is centered on a bearing of 45 degrees, as indicated by bearing line 116. In a situation where the signal resulting in the FIG. 6 display was received shortly after the example signal of FIGS. 3 and 4, displaying the combined bearing and uncertainty may comprise displaying overlapping circular sections 114A and 114B, and a resulting overlapping area 115, as shown in FIG. 7, with section 114B of FIG. 7 corresponding to section 114 of FIG. 6, and section 114A of FIG. 7 corresponding to section 114 of FIGS. 3 and 4. Alternatively, displaying the combined bearing and uncertainty may comprise displaying only the overlapping area 115, as shown in FIG. 8.

The overlapping area 115 represents a region of greater probability for locating the target T. In some embodiments overlapping area 115 is shown in a different color or intensity from sections 114, so that area 115 may readily be distinguished by a user. In some embodiments, darker colors are used to indicate areas where more sections 114 overlap.

In each of the FIG. 7 and FIG. 8 examples, the heading indicator 108 displays the most recently determined bearing, but in other embodiments the heading indicator may display an average bearing, or a weighted average bearing, with greater weight being given to bearings determined from more recently received signals. This allows for a continuously updated probability map indicating the likely directions to the target, allowing for continued movement of the target T with respect to the receiver device 100. For example, if 5 signals are used, the most recent signal could have a weight of 5, the next most 4, and so on, down to 1. An overlapping area between the signal with weight 5, and the signal with weight 3, would have a combined weight of 8. The intensity of this circular sectional area would be displayed proportionately. This method gives greater relevance to more recent signals, since the older signals were received when the target T may have been in a different location. In some embodiments, the user may reset the display and manually reject older signals.

FIG. 9 shows another example where a third signal has been received, and displaying the combined bearing and uncertainty comprises displaying an additional section 114C based on the third signal in addition to sections 114A and 114B. The resulting overlapping area 115 of FIG. 9 where all of sections 114A-C (collectively referred to as sections 114) overlap is smaller than in FIGS. 7 and 8.

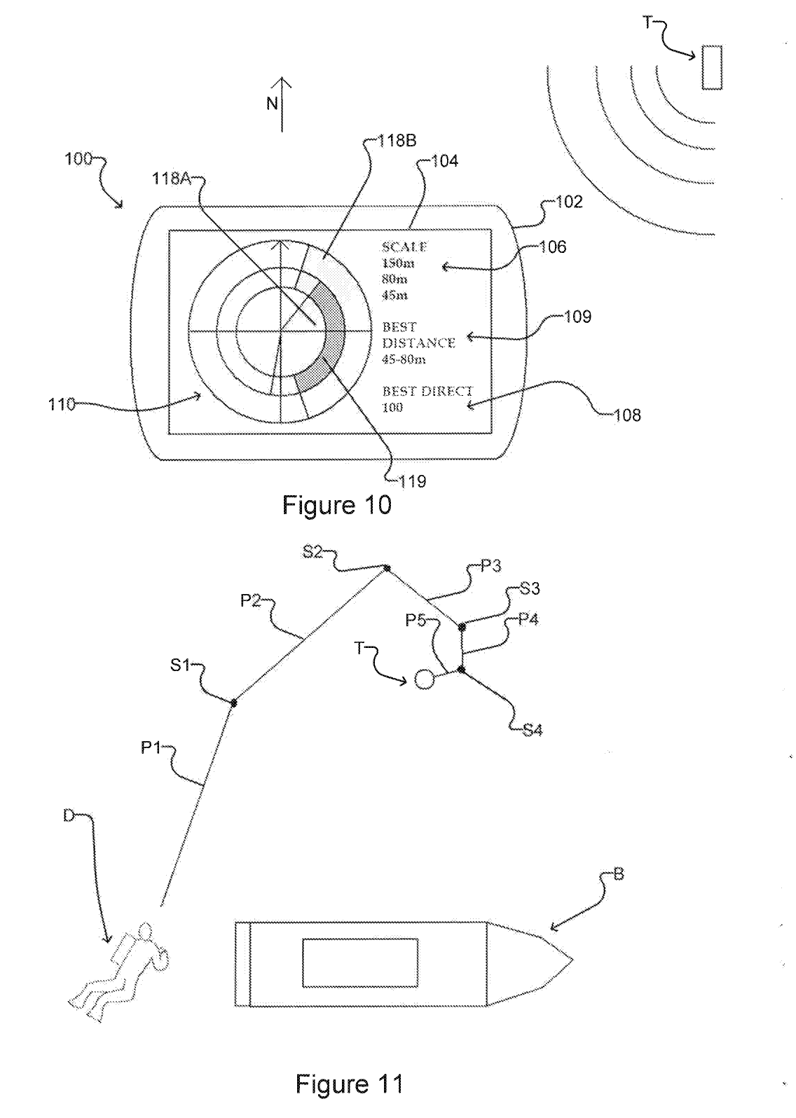

FIG. 10 shows another example where the receiver device 100 device is capable of estimating the distance to the target. In the FIG. 10 example distance information is shown in the scale indicator 106, and is also indicated on the map 110. The concentric circles on the map 10 in FIG. 10 represent the different scale distances of 150 meters (outermost circle), 80 meters (middle circle) and 45 meters (innermost circle) shown in the scale indicator. A circular section 118 extends from the center of the map 110 to the middle circle, indicating that the signal associated with that section is estimated to originate from a distance between 0 and 80 meters. An annular section 118B extends from the innermost circle to the outermost circle, indicating that the signal associated with that section is estimated to originate from a distance between 45 and 150 meters. In such embodiments, the display 104 may also show a distance indicator 109 where the most likely estimated distance is displayed, in this example, 45 to 80 meters.

FIG. 11 illustrates how a diver D may use a receiver device as disclosed herein to locate a target T. The diver starts out on path P1 based on a bearing indication displayed based on an initial signal from the target T. At point S1 another signal is received, and updated bearing information is displayed and the diver D continues on path P2. Additional signals are received at each of points S2, S3 and S4, which cause the receiver device to display updated bearing information and the diver D corrects course along paths P3, P4 and P5 to zero in on the target T. FIG. 11 also shows an optional dive boat B for reference.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. An electronic device for locating an underwater target transmitting a signal, the electronic device comprising:
a housing;
a display;
at least one transducer for receiving the signal from the underwater target;
a processor connected to receive signals from the at least one transducer and to control the display; and
a memory storing computer readable instructions which, when executed by the processor, cause the processor to:
determine a bearing to the underwater target based on the signals from the at least one transducer;
determine an uncertainty in the determined bearing; and,
control the display to display the determined bearing and uncertainty.

2. The electronic device of claim 1 wherein the display displays a graphical representation of the determined bearing and uncertainty on a generally circular map centered on the electronic device, wherein the graphical representation of the determined bearing and uncertainty comprises a circular section centered on the determined bearing and having an angular extent based on the uncertainty.

3. The electronic device of claim 1 wherein a second bearing and uncertainty are determined based on a subsequent signal received from the underwater target.

4. The electronic device of claim 3 wherein the display displays a graphical representation of the second bearing and uncertainty superimposed over a graphical representation of the determined bearing and uncertainty.

5. The electronic device of claim 3 wherein the display displays an overlap portion of the determined bearing and uncertainty, and the second bearing and uncertainty.

6. The electronic device of claim 1 wherein the processor determines a combined bearing and uncertainty based on a plurality of successively received signals from the underwater target.

7. The electronic device of claim 6 wherein the processor determines the combined bearing and uncertainty based on a weighted average of the successively received signals and wherein more recently received signals are given greater weight in determining the combined bearing and uncertainty.

8. The electronic device of claim 6 wherein the display displays a graphical representation of the combined bearing and uncertainty on a generally circular map centered on the electronic device, wherein the graphical representation of the combined bearing and uncertainty comprises, for each of a plurality of the successively received signals, a circular section centered on the determined bearing for that signal and having an angular extent based on the uncertainty for that signal, and wherein the circular sections are superimposed on one another.

9. The electronic device of claim 1 wherein the electronic device estimates a distance to the underwater target and the display displays a scale indicator based on the estimated distance.

10. The electronic device of claim 9 wherein the display displays a graphical representation of the estimated distance.

11. A method for locating an underwater target transmitting a signal, the method comprising:
receiving the signal from the underwater target;
determining a bearing to the underwater target based on the signal;
determining an uncertainty in the determined bearing; and,
displaying the determined bearing and uncertainty on a display.

12. The method of claim 11, further comprising displaying a graphical representation of the determined bearing and uncertainty on a generally circular map centered on the electronic device, wherein the graphical representation of the determined bearing and uncertainty comprises a circular section centered on the determined bearing and having an angular extent based on the uncertainty.

13. The method of claim 11 further comprising determining a second bearing and uncertainty are based on a subsequent signal received from the underwater target.

14. The method of claim 13 further comprising displaying on the display a graphical representation of the second bearing and uncertainty superimposed over a graphical representation of the determined bearing and uncertainty.

15. The method of claim 13 further comprising displaying on the display an overlap portion of the determined bearing and uncertainty, and the second bearing and uncertainty.

16. The method of claim 11 wherein determining the determined bearing and uncertainty comprises determining a combined bearing and uncertainty based on a plurality of successively received signals from the underwater target.

17. The method of claim 16 wherein determining the combined bearing and uncertainty is based on a weighted average of the successively received signals and wherein more recently received signals are given greater weight in determining the combined bearing and uncertainty.

18. The method of claim 16 comprising displaying a graphical representation of the combined bearing and uncertainty on a generally circular map centered on the electronic device, wherein the graphical representation of the combined bearing and uncertainty comprises, for each of a plurality of the successively received signals, a circular section centered on the determined bearing for that signal and having an angular extent based on the uncertainty for that signal, and wherein the circular sections are superimposed on one another.

19. The method of claim 11 further comprising estimating a distance to the underwater target and displaying on the display a scale indicator based on the estimated distance.

20. The method of claim 19 further comprising displaying on the display a graphical representation of the estimated distance.
